(19) United States
(12) Patent Application Publication
(10) Pub. No.: US 2025/0360982 A1
(43) Pub. Date: Nov. 27, 2025

(54) COOLING ASSEMBLY FOR A TWO-WHEELED VEHICLE

(71) Applicant: Indian Motorcycle International, LLC, Medina, MN (US)

(72) Inventors: Joseph W. Klein, Wyoming, MN (US); Kiran Varanasi, Hyderabad (IN); Haolun Fan, Wyoming, MN (US); Bret RempelEwert, Shafer, MN (US); Juho Pekka Wuollet, Wyoming, MN (US); Steven F. Kruger, Wyoming, MN (US)

(73) Assignee: Indian Motorcycle International, LLC, Medina, MN (US)

(21) Appl. No.: 18/872,641

(22) PCT Filed: Jun. 6, 2023
(86) PCT No.: PCT/US2023/068015

§ 371 Date: Dec. 6, 2024

Related U.S. Application Data
(60) Provisional application No. 63/349,813, filed on Jun. 7, 2022.

(51) Int. Cl. B62J 41/00; B62K 11/04

(52) U.S. Cl. CPC B62J 41/00; B62K 11/04

(57) ABSTRACT

A two-wheeled vehicle may comprise a frame, a plurality of ground-engaging members for supporting the frame and an engine supported by the frame assembly. Additionally, the two-wheeled vehicle may comprise a cooling assembly including a radiator, a radiator cover, a fan and a coolant bottle. The cooling assembly may comprise a single unit such that all components are coupled to each other and may be installed, removed, or rotated as a single structural unit. The coolant bottle may be positioned below the radiator. The radiator cover may have a plurality of horizontal louvers and a plurality of vertical louvers, both positioned to protect from debris and capture airflow.

### RELATED APPLICATION

This application claims the benefit of U.S. Provisional Patent Application No. 63/349,813, filed Jun. 7, 2022, the entire disclosure of which is expressly incorporated by reference herein.

### FIELD OF THE DISCLOSURE

The present disclosure relates to a cooling assembly for a vehicle and, more particularly, to a radiator cover and coolant bottle for a two-wheeled vehicle.

### BACKGROUND OF THE DISCLOSURE

Conventional two-wheeled vehicles include a frame for supporting an operator. The frame may also support a passenger rearward of the driver. An engine is typically positioned below the driver and is coupled to the frame. The front of the vehicle may include a panel or cover positioned forward of the driver for supporting additional components of the vehicle, for example a light. The rear of the vehicle may include a cargo area, for example saddle bags extending laterally outward from the frame.

Such vehicles typically include a cooling assembly fluidly coupled to the engine. The cooling assembly may include a radiator, fans, coolant, fluid conduits, and various other components. Because space on such vehicle may be constricted, there is a need to support the cooling assembly on a two-wheeled vehicle without interference with other components of the vehicle.

### SUMMARY OF THE DISCLOSURE

In an exemplary embodiment of the present disclosure, a two-wheeled vehicle comprises a frame including a down tube and a plurality of ground-engaging members for supporting the frame. Additionally, the two-wheeled vehicle comprises a cooling assembly including a radiator and a radiator cover. The radiator cover includes a plurality of horizontal louvers and a plurality of vertical louvers.

A further exemplary embodiment of the present disclosure includes a two-wheeled vehicle comprising a frame including a down tube, a mounting arm on the down tube and a plurality of ground-engaging members for supporting the frame. Additionally, the two-wheeled vehicle comprises a cooling assembly including a radiator, a fan, a radiator cover and a coolant bottle as a single structural unit.

A further exemplary embodiment of the present disclosure includes a two-wheeled vehicle comprising a frame including a down tube, a mounting arm on the down tube and a plurality of ground-engaging members for supporting the frame. Additionally, the two-wheeled vehicle comprises a cooling assembly including a radiator, a fan, and a coolant bottle. The coolant bottle is positioned below the radiator.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a left side view of a schematic representation of a two-wheeled vehicle of the present disclosure;

FIG. 2 is a top view of the two-wheeled vehicle of FIG. 1;

FIG. 3 is a left front perspective view of a portion of a frame and a cooling assembly coupled for the vehicle of FIG. 1;

FIG. 4 is a partially exploded view of the cooling assembly of FIG. 3;

FIG. 5 is a front view of a radiator cover with horizontal and vertical louvers of the cooling assembly of FIG. 3;

FIG. 6 is a top left perspective view of a pivot mount of the radiator of the cooling assembly of FIG. 3;

FIG. 7 is an exploded view of the radiator of the cooling assembly and the frame of FIG. 3;

FIG. 8 is a right rear perspective view of the cooling assembly and the frame of FIG. 3;

FIG. 9 is a rear exploded view of the of a portion of the cooling assembly of FIG. 3; and

FIG. 10 is a left rear view of a coolant bottle of the cooling assembly of FIG. 3.

Corresponding reference characters indicate corresponding parts throughout the several views. Unless stated otherwise the drawings are proportional.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present invention primarily involves a standard motorcycle, it should be understood, that the invention may have application to other types of vehicles such as all-terrain vehicles, motorcycles, watercraft, utility vehicles, scooters, golf carts, and mopeds.

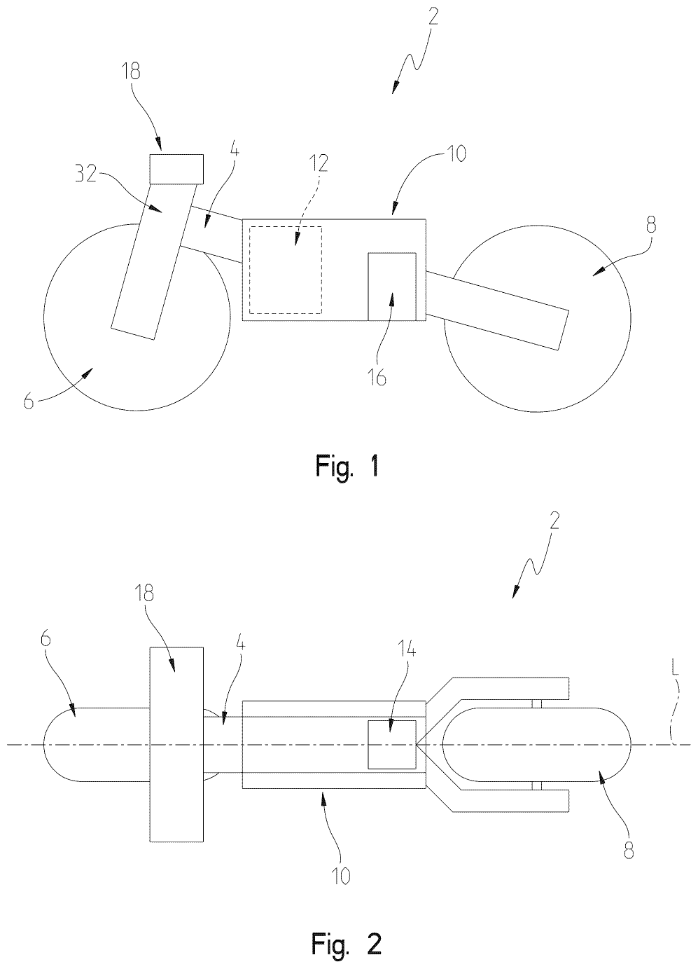

With reference first to FIGS. 1-2, an illustrative embodiment of a two-wheeled vehicle 2 is shown. Vehicle 2 as illustrated is a motorcycle and may be configured for cruising, touring, sport, dirt bike, or other various operational applications as described herein.

Vehicle 2 includes a frame 4 supported by ground engaging members, namely a front ground engaging member, illustratively front wheel 6, and a rear ground engaging member, illustratively rear wheel 8. Vehicle 2 travels relative to the ground on front wheel 6 and rear wheel 8. The front wheel 6 and rear wheel 8 are generally aligned along a centerline L of vehicle 2. While vehicle 2 is a two-wheeled vehicle, various embodiments of the present disclosure may include three, four, five or six-wheeled vehicles. A front fender (not shown) may be partially positioned around the front wheel 6 and may include a light or reflector. Similarly, a rear fender (not shown) may be positioned around the rear wheel 8. Additionally, a brake assembly (not shown) is operably coupled to the front wheel 6 and/or rear wheel 8.

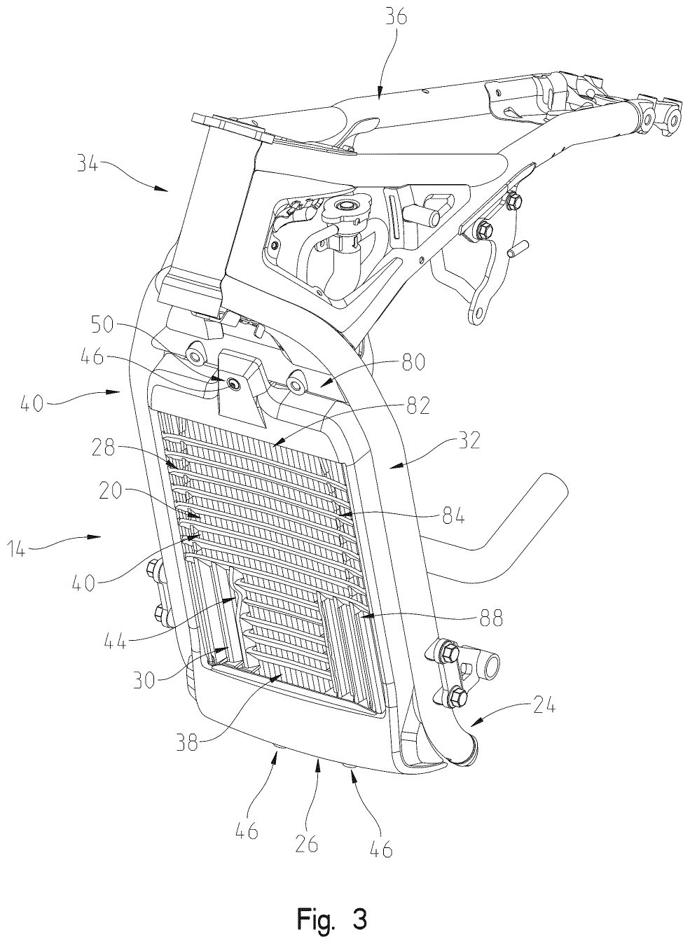

Frame 4 of vehicle 2 may include a mid-frame assembly 10 for supporting a powertrain assembly 12. Mid-frame assembly 10 or other portions of frame 4, such as a front frame portion or a rear frame portion may support a cooling assembly 14 (FIG. 3), a fuel tank 16, a rear suspension assembly, and an operator seat. Front and/or rear wheel(s) 6, 8 is operably coupled to power train assembly 12 to propel vehicle 2 along the ground surface. Powertrain assembly 12 may include both an engine and a transmission. The engine may be a spark-ignition gasoline engine, electric motor or other suitable torque-generating machines that are operable with various embodiments of the present teachings.

Vehicle 2 also includes a front suspension assembly, a steering assembly 18, operator controls and other systems. Steering assembly 18 includes handlebars which may be moved by an operator to rotate front wheel 6 either to the left or the right. Steering assembly 18 is coupled to vehicle 2 through a triple clamp assembly. The triple clamp assembly may be operably coupled the front suspension assembly through down tubes.

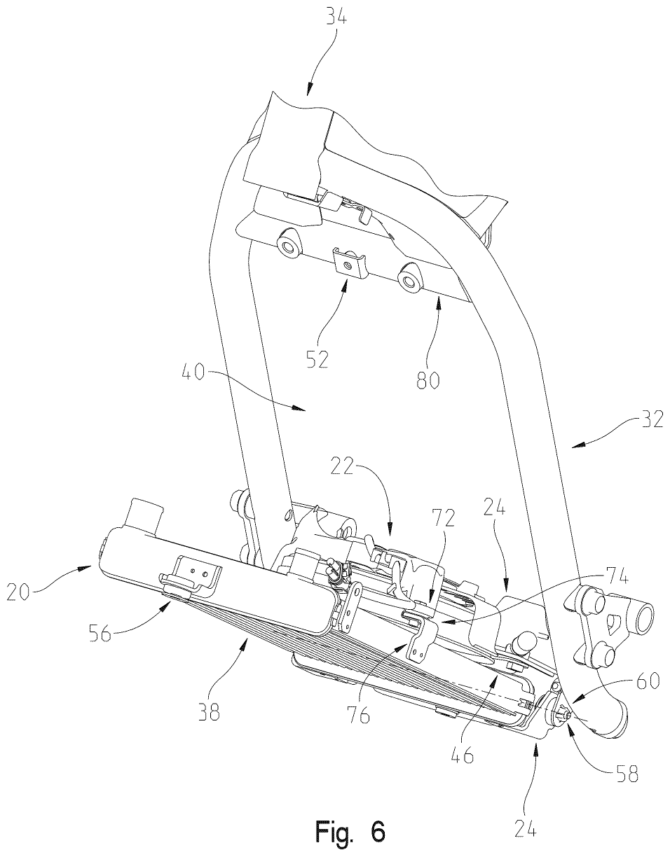

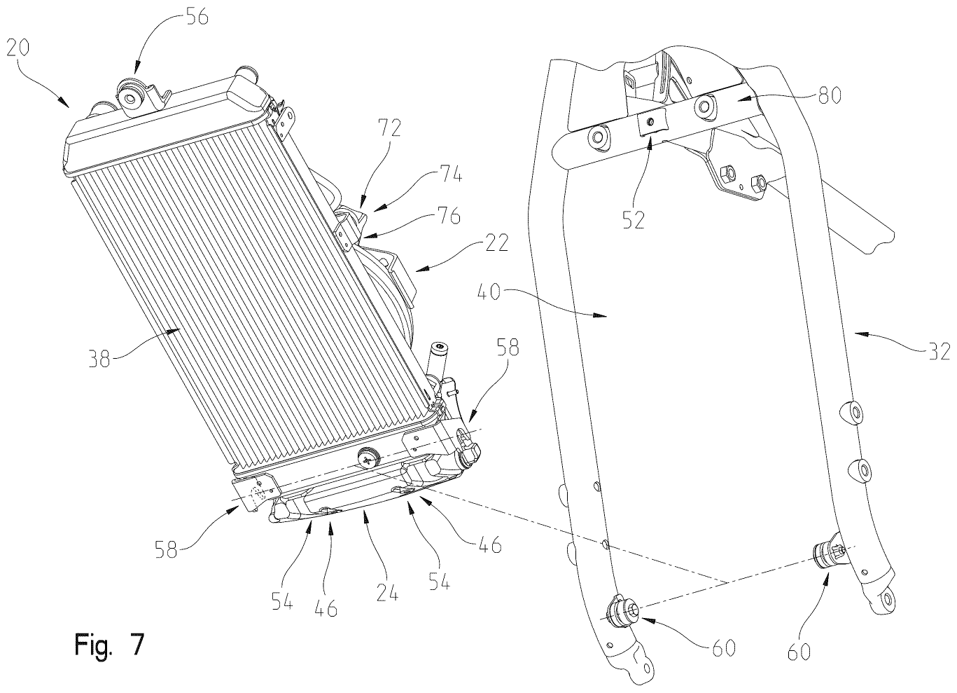

Referring now to FIGS. 3-10, cooling assembly 14 comprises a radiator cover 26, radiator 20 positioned rearward of the radiator cover, a fan 22 positioned rearward of radiator 20 and a coolant bottle 24 positioned below fan 22 and radiator 20. Radiator 20 includes a plurality of vertical fins 38. The radiator cover 26 has a plurality of horizontal louvers 28 and a plurality of vertical louvers 30. Louvers 28, 30 are both a straight plane shape.

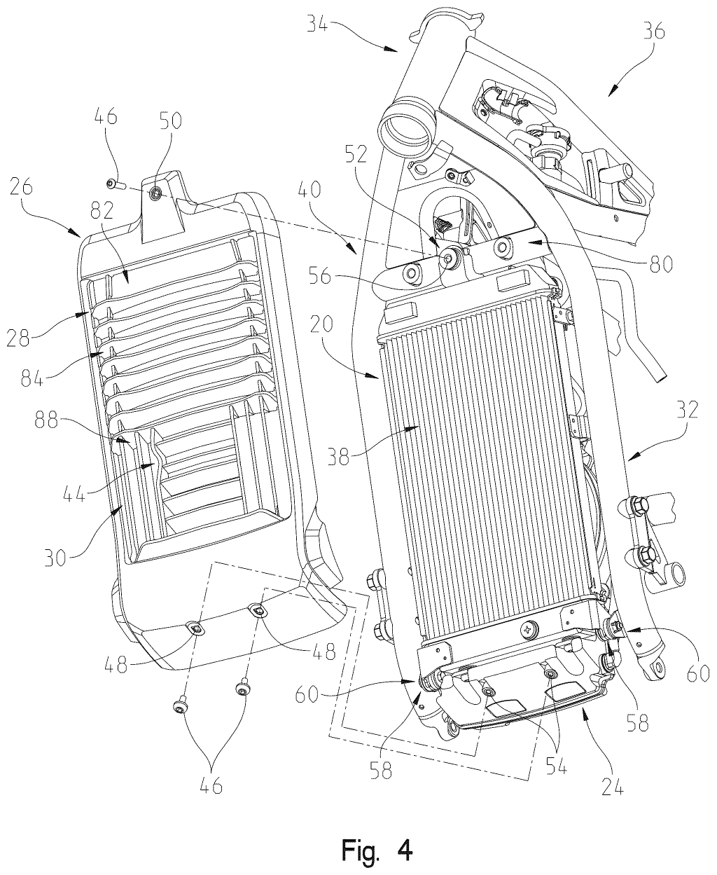

As shown in FIGS. 3 and 4, radiator cover 26 surrounds at least a front surface of radiator 20 and coolant bottle 24. Radiator cover 26 is removably coupled to down tubes 32 through a cross-member 80 of frame 4 with a fastener 46 extending through an upper aperture 50 of cover 26. Additionally, cover 26 is removably coupled to coolant bottle 24 with fasteners 46 extending through lower apertures of cover 26. More particularly, and as shown in FIG. 4, radiator cover 26 removably couples with coolant bottle 24 when lower apertures 48 of cover 26 align with apertures 54 on coolant bottle 24 and removably couples with down tubes 32 (via cross-member 80) when upper aperture 50 of cover 26 is aligned with aperture 52 of cross-member 80. In this way, cover 26 is removably coupled from vehicle 2 to access radiator 20 and is coupled to vehicle 2 through a frame member and coolant bottle 24.

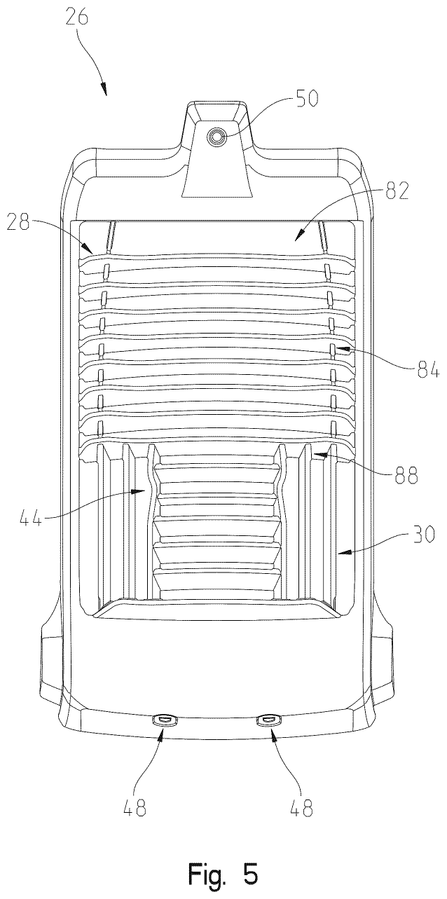

Radiator cover 26 has a plurality of horizontal louvers 28 that are positioned along an upper extent of cover 26. Illustratively, horizontal louvers 28 extend laterally along at least an upper half of cover 26 and, as shown in FIG. 5, horizontal louvers 28 are positioned on the top and center portion of radiator cover 26. In one embodiment, horizontal louvers 28 also extend along at least a partial width of a lower extent of cover 26. Radiator cover 26 provides the dual benefit of protecting the radiator 20 from debris damage and acting as a guide to direct airflow into radiator 20. There is a gap 82 between uppermost horizontal louver 28 and the top of radiator cover 26 to facilitate air flow into radiator 20.

Airflow generally passes into the radiator from a vertical direction over the top of front wheel 6 and fender, as well as laterally around the sides of front wheel 6. Most of the airflow into radiator 20 first passes front wheel 6 and fender which direct the air down in a vertical direction towards radiator cover 26. For this reason, the top of radiator cover 26 has a plurality of horizontal louvers 28 positioned at an angle to catch the airflow that is directed vertically downward. The lateral airflow which comes around front wheel 6 in a lateral direction down vehicle 2 centerline L, is captured by vertical louvers 30 which are positioned on the lower left and right sides of radiator cover 26. At the bottom center portion of radiator cover 26, lower horizontal louvers 28 may be positioned laterally intermediate to a first or left side grouping of vertical louvers 30 and a second or right side grouping of vertical louvers 30. Lower horizontal louvers 28 capture vertical airflow to this area of radiator cover 26.

Illustratively, horizontal louvers are aligned horizontally and generally parallel to each other. Vertical louvers 30 are aligned vertically and generally parallel to each other. In one embodiment, vertical louvers 30 may be positioned at an angle of at least 0 to 45 degrees from centerline L. Horizontal louvers 28 are generally perpendicular to vertical louvers 30. The angle of vertical louvers 30 may be constant for all or varied for each individual vertical louver 30 to maximize airflow capture. The laterally outermost vertical louver 30 may extend from the bottom of radiator cover 26 to the interface 88 with the horizontal louvers. A vertical support 86 may be positioned between the laterally outermost extent of vertical louver 30 and the exterior vertical side of the radiator cover 26. The vertical support 86 may extend vertically from the top of the lowest horizontal louver to the top of radiator cover 26. Additionally, vertical support 86 may extend vertically through a cutout portion 84 in horizontal louvers 28 to provide stability and structural support to horizontal louvers 28 and radiator cover 26. The vertical support 86 may be aligned with the laterally outermost vertical louver 30 to provide a congruous aesthetic. The vertical support 86 provides structural support to radiator cover 26 and horizontal louvers 28.

The lower center horizontal louvers 28 may be coupled to the vertical louvers 30. The laterally innermost vertical louver 30 may have a recessed portion 44 which defines a clearance for the fender. The spacing of both horizontal louvers 28 and vertical louvers 30 is chosen to minimize debris impacting radiator 20. Vertical louvers 30 provide the benefit of capturing more airflow than with only horizontal louvers 28 in two ways. First, vertical louvers 30 directly capture the lateral airflow around front wheel 6. Second, vertical louvers 30 indirectly impact the turbulence at the lower portion of radiator cover 26 which creates more undisturbed airflow for horizontal louvers 28 to capture. As a result of the greater airflow capture, a smaller radiator 20 may be installed on vehicle 2 which provides several benefits such as increased space for other components, decreased weight of vehicle 2 and improved performance characteristics among other benefits.

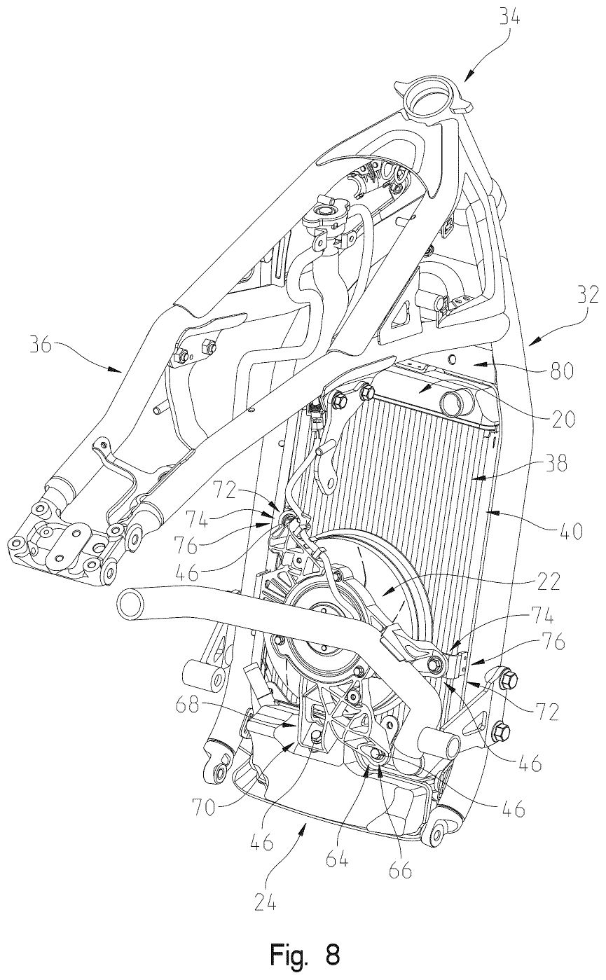

As shown in FIGS. 4, 6, 7, and 8, cooling assembly 14 is supported on down tubes 32 and below head tube 34. More particularly, radiator 20 is supported within a pocket 40 (FIG. 7) of frame 4 such that head tube 34 and down tubes 32 generally surround cooling assembly 14. Cooling assembly 14 is installed forward of longitudinally extending frame arms 36 (FIG. 8) of frame 4. The lower portion of cooling assembly 14 is mounted to mounting pegs 60 of down tubes 21 with brackets 58 of radiator 58. In one embodiment, mounting pegs 60 are defined by a peg extending laterally inward from each down tube 32 and a vibration isolator may be positioned on the peg. Illustratively, brackets 58 are removably or permanently coupled to a lower portion of radiator 20 and include a U-shaped channel configured to receive mounting pegs 60. Mounting pegs 60 are coupled to the lower portion of the down tubes 32. Bracket 58 is a pivot type mount that enables radiator 20 to rotate around mounting arms 60. Installation of radiator 20 involves placing brackets 58 on mounting pegs 60 and then rotating radiator 20 upwardly into position generally between the down tubes 32 and cross-member 80. Radiator 20 is maintained in this position when an upper aperture 56 of radiator 20 is aligned with an aperture 52 on cross-member 80, and then inserting fastener 46 (FIG. 4). It may be appreciated that fastener 46 is the same fastener 46 that also couples cover 26 to cross-member 80 such that apertures 50, 52, 56 are aligned to receive a single fastener 46 to couple an upper end of both radiator 20 and cover 26 to frame 4. Aperture 56 may be defined within a bracket 62 of radiator 20. Radiator 20 may be rotated freely on brackets 58 about the center axis of mounting pegs 60 without needing to remove any of the individual components of cooling assembly 14. There are several benefits of bracket 58: first, brackets 58 provide simplified installation and removal of the entire cooling assembly 14 as a complete unit rather than needing to install or remove each component individually; and second, brackets 58 provide ease of access to other components on vehicle 2 by removing fastener 46 from aperture 52 and rotating cooling assembly 14 outwardly from down tubes 32, rather than needing to remove the entire cooling assembly 14. Finally, there is greater freedom to package exhaust and other components on vehicle 2 because cooling assembly 14 is a single, movable unit.

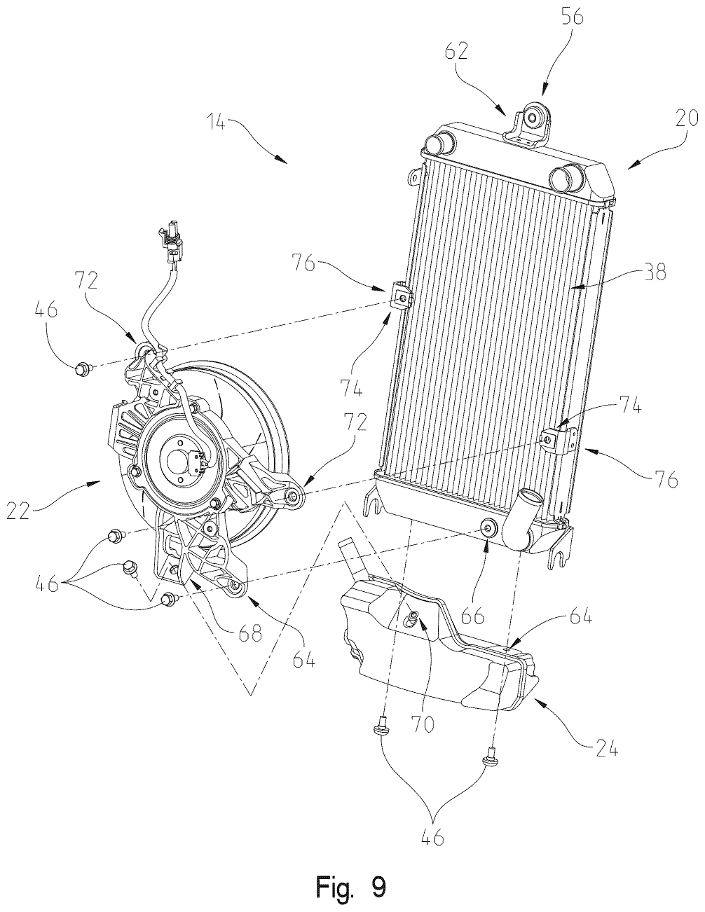

Referring to FIG. 9, radiator 20, fan 22 and coolant bottle 24 are coupled together by fasteners 46. Coolant bottle 24 is coupled to radiator 20 and is positioned directly under the lower portion of radiator 20 by aligning aperture 64 of coolant bottle 24 with aperture 66 of radiator 20 and inserting fastener 46. The location of coolant bottle 24 positions coolant bottle 24 in an unutilized position of vehicle 2 which creates additional space for other components elsewhere and reduces mounting points on the single unit cooling assembly 14. Fan 22 is coupled to coolant bottle 24 by aligning aperture 68 of a fan bracket with aperture 70 of coolant bottle 24 and inserting fastener 46. Fan 22 is coupled to radiator 20 by aligning apertures 72 on the fan bracket with apertures 74 on radiator 20 and inserting fasteners 46. Apertures 74 are located on mounting arms 76 on either side of radiator 20. When radiator 20, radiator cover 26, fan 22 and coolant bottle 24 are coupled together, they form the single unit cooling assembly 14.

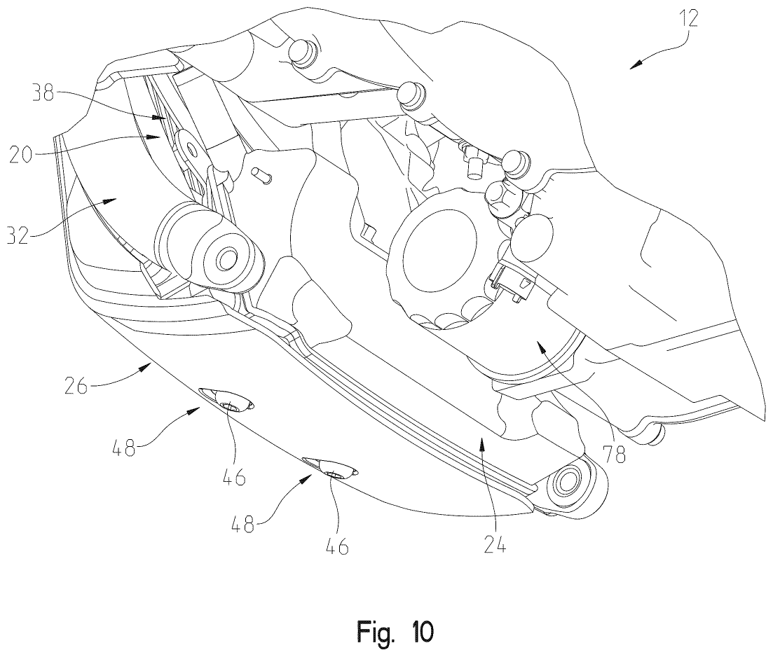

Referring to FIG. 10, radiator cover 26 wraps around the bottom of coolant bottle 24. Radiator cover 26 protects coolant bottle 24 from debris. Coolant bottle 24 is positioned forward of a portion of powertrain assembly 12, such as a front end of the crankcase of the engine and an oil filter 78. Coolant bottle 24 is illustratively positioned adjacent the lower ends of down tubes 32. The shape of coolant bottle 24 facilitates access to oil filter 78.

### EXAMPLES

Example 1: A two-wheeled vehicle may comprise a frame including a down tube; a plurality of ground engaging members for supporting the frame; and a cooling assembly including a radiator and a radiator cover. The radiator cover may include a plurality of horizontal louvers and a plurality of vertical louvers.

Example 2: The two-wheeled vehicle of Example 1, wherein the vertical louvers may be positioned at an angle at least 0 to 45 degrees from a vehicle centerline.

Example 3: The two-wheeled vehicle of Example 1, wherein the radiator cover may be coupled to the down tube and the radiator.

Example 4: The two-wheeled vehicle of Example 1, wherein the innermost vertical louvers of the plurality of vertical louvers may be separated by a plurality of horizontal louvers.

Example 5: The two-wheeled vehicle of Example 1, wherein the horizontal louvers may be generally parallel to each other and perpendicular to the vertical louvers.

Example 6: The two-wheeled vehicle of Example 1, wherein the vertical louvers may be generally parallel to each other and perpendicular to the horizontal louvers.

Example 7: The two-wheeled vehicle of Example 1, wherein the plurality of vertical louvers may extend vertically from the bottom of the radiator cover to the interface with the horizontal louvers.

Example 8: The two-wheeled vehicle of Example 1, wherein the plurality of vertical louvers may have a recessed portion.

Example 9: The two-wheeled vehicle of Example 1, wherein the radiator cover and the radiator may be coupled to the frame at a same location.

Example 10: A two-wheeled vehicle may comprise a frame including a down tube and a mounting arm on the down tube; a plurality of ground engaging members for supporting the frame; and a cooling assembly. The cooling assembly may include a radiator, fan, a radiator cover, and coolant bottle as a single structural unit.

Example 11: The two-wheeled vehicle of Example 10, wherein the radiator may be pivotably mounted to the down tube.

Example 12: The two-wheeled vehicle of Example 10, wherein the fan, and coolant bottle may be coupled to the radiator.

Example 13: The cooling assembly of Example 10, wherein all components may move with the radiator as a single structural unit relative to the frame.

Example 14: The two-wheeled vehicle of Example 10, wherein the radiator cover and the radiator may be coupled to the frame at a same location.

Example 15: A two-wheeled vehicle, may comprise a frame including a down tube and a mounting arm on the down tube; a plurality of ground engaging members for supporting the frame; and a cooling assembly. The cooling assembly may include a radiator, a fan and a coolant bottle positioned below the radiator.

Example 16: The two-wheeled vehicle of Example 15, wherein the fan and the coolant bottle may be coupled to the radiator.

Example 17: The two-wheeled vehicle of Example 15, wherein the fan, the coolant bottle, and the radiator may move together relative to the frame.

Example 18: The two-wheeled vehicle of Example 15, wherein the fan may be positioned above the coolant bottle and behind the radiator. The fan may be coupled to the coolant bottle and the radiator.

Example 19: The two-wheeled vehicle of Example 15, wherein the cooling assembly may be pivotably coupled to the frame.

While this invention has been described as having an exemplary design, the present invention may be further modified within the spirit and scope of this disclosure. This application is therefore intended to cover any variations, uses or adaptations of the invention using its general principles. Further, this application is intended to cover such departures from the present disclosure as come within known or customary practice in the art to which this invention pertains.

What is claimed is:

1. A two-wheeled vehicle, comprising:
a frame including a down tube;
a plurality of ground engaging members for supporting the frame; and
a cooling assembly including a radiator and a radiator cover, and the radiator cover includes a plurality of horizontal louvers and a plurality of vertical louvers.

2. The two-wheeled vehicle of claim 1, wherein the vertical louvers are positioned at an angle at least 0 to 45 degrees from a vehicle centerline.

3. The two-wheeled vehicle of claim 1, wherein the radiator cover is coupled to the down tube and the radiator.

4. The two-wheeled vehicle of claim 1, wherein the innermost vertical louvers of the plurality of vertical louvers are separated by a plurality of horizontal louvers.

5. The two-wheeled vehicle of claim 1, wherein the horizontal louvers are generally parallel to each other and perpendicular to the vertical louvers.

6. The two-wheeled vehicle of claim 1, wherein the vertical louvers are generally parallel to each other and perpendicular to the horizontal louvers.

7. The two-wheeled vehicle of claim 1, wherein the plurality of vertical louvers extend vertically from the bottom of the radiator cover to the interface with the horizontal louvers.

8. The two-wheeled vehicle of claim 1, wherein the plurality of vertical louvers have a recessed portion.

9. The two-wheeled vehicle of claim 1, wherein the radiator cover and the radiator are coupled to the frame at a same location.

10. A two-wheeled vehicle, comprising:
a frame including a down tube and a mounting arm on the down tube;
a plurality of ground engaging members for supporting the frame; and
a cooling assembly including a radiator, fan, a radiator cover, and coolant bottle as a single structural unit.

11. The two-wheeled vehicle of claim 10, wherein the radiator is pivotably mounted to the down tube.

12. The two-wheeled vehicle of claim 10, wherein the fan, and coolant bottle are coupled to the radiator.

13. The cooling assembly of claim 10, wherein all components move with the radiator as a single structural unit relative to the frame.

14. The two-wheeled vehicle of claim 10, wherein the radiator cover and the radiator are coupled to the frame at a same location.

15. A two-wheeled vehicle, comprising:
a frame including a down tube and a mounting arm on the down tube;
a plurality of ground engaging members for supporting the frame; and
a cooling assembly including a radiator, a fan and a coolant bottle positioned below the radiator.

16. The two-wheeled vehicle of claim 15, wherein the fan and the coolant bottle are coupled to the radiator.

17. The two-wheeled vehicle of claim 15, wherein the fan, the coolant bottle, and the radiator move together relative to the frame.

18. The two-wheeled vehicle of claim 15, wherein the fan is positioned above the coolant bottle and behind the radiator, and the fan is coupled to the coolant bottle and the radiator.

19. The two-wheeled vehicle of claim 15, wherein the cooling assembly is pivotably coupled to the frame.
